(19) United States
(12) Patent Application Publication
(10) Pub. No.: US 2024/0103816 A1
(43) Pub. Date: Mar. 28, 2024

(54) VISUAL LOGIC EXECUTION METHOD, SYSTEM, AND DEVICE, AND MEDIUM

(71) Applicant: SHANGHAI LILITH TECHNOLOGY CORPORATION

(72) Inventor: Di WU, Shanghai (CN)

(21) Appl. No.: 17/768,829

(22) PCT Filed: Sep. 11, 2020
(86) PCT No.: PCT/CN2020/114737

§ 371 Date: Apr. 13, 2022

(30) Foreign Application Priority Data
Oct. 30, 2019 (CN) 201911042970.7

(51) Int. Cl. G06F 8/30; G06F 8/34

(52) U.S. Cl. CPC G06F 8/313; G06F 8/34

(57) ABSTRACT

The present invention relates to the technical field of game development and logic editors, and in particular, to a visual logic execution method, system, and device, and medium. The method of the present invention comprises: when a specific event occurs, searching for an event node associated with the specific event serving as a child node under an object node associated with an object in the specific event, where the object node and the event node are comprised in a node list arranged as a tree structure; and executing logic in the event node. A third-party reader can quickly understand how the logic in game design is executed, so that communication and learning of developers of different games can be facilitated, and an affiliation relationship between the specific event and the object in the specific event in a node list can be intuitively displayed.

### TECHNICAL FIELD

The present invention relates to the technical field of game development and logic editors, and in particular, to a visual logic execution method, system, and device, and medium.

### BACKGROUND

In a typical unity project, when to execute a script is obtained by parsing content in the script. A typical unity script is as follows:
Void start( )
//The content here is immediately executed after a game runs
Void update( )
//The content here is repeatedly executed in each frame

Through parsing, it can be concluded that part of the specific content in the above script is immediately executed after the game runs, and another part of the specific content is repeatedly executed in each frame. Although logic of this design is complete, it is not intuitive enough for third-party readers, and costs of understanding are high. Each script needs to be opened for reading to understand what logic is executed when the game is running.

### SUMMARY

An objective of the present invention is to provide a visual logic execution method, system, and device, and medium, and third-party readers can quickly understand how the logic in game design is executed, so that communication and learning of different game developers are facilitated, and an affiliation relationship between a specific event and an object in the specific event can be intuitively displayed in a node list.

An implementation of the present invention discloses a visual logic execution method, wherein the method comprises:
when a specific event occurs, searching for an event node associated with the specific event serving as a child node under an object node associated with an object in the specific event, wherein the object node and the event node are comprised in a node list arranged as a tree structure; and
executing logic in the event node.

Optionally, the specific event comprises a collision event, two or more objects collide in the collision event, and the objects in the specific event comprise the two or more objects that collide.

Optionally, the specific event comprises a value object change event, a function is used in the value object change event to change a value of an object, and the object in the specific event comprises the object whose value is changed.

Optionally, a parent-child relationship between the event node and the object node is set based on an affiliation relationship between the specific event and the object in the specific event.

An implementation of the present invention discloses a visual logic execution system, wherein the system comprises:
a searching unit, configured to, when a specific event occurs, search for an event node associated with the specific event serving as a child node under an object node associated with an object in the specific event, wherein the object node and the event node are comprised in a node list arranged as a tree structure; and
an execution unit, configured to execute logic in the event node.

Optionally, the specific event comprises a collision event, two or more objects collide in the collision event, and the objects in the specific event comprise the two or more objects that collide.

Optionally, the specific event comprises a value object change event, a function is used in the value object change event to change a value of an object, and the object in the specific event comprises the object whose value is changed.

Optionally, a parent-child relationship between the event node and the object node is set based on an affiliation relationship between the specific event and the object in the specific event.

An implementation of the present invention discloses a visual logic execution device, wherein the device comprises a memory storing computer executable instructions and a processor, the processor is configured to execute the instructions to implement a visual logic execution method, and the methods comprises:
when a specific event occurs, searching for an event node associated with the specific event serving as a child node under an object node associated with an object in the specific event, wherein the object node and the event node are comprised in a node list arranged as a tree structure; and
executing logic in the event node.

An implementation of the present invention discloses a computer storage medium encoded with a computer program, wherein the computer program comprises instructions, and the instructions are executed by one or more computers to implement a visual logic execution method, and the method comprises:
when a specific event occurs, searching for an event node associated with the specific event serving as a child node under an object node associated with an object in the specific event, wherein the object node and the event node are comprised in a node list arranged as a tree structure; and
executing logic in the event node.

Compared with the prior art, main differences and effects of the implementations of the present invention are as follows:

In the present invention, when a specific event occurs, if there is an event node associated with the specific event serving as a child node under an object node associated with an object in the specific event, logic in the event node is executed, and a third-party reader can quickly understand how the logic in game design is executed, so that communication and learning of developers of different games are facilitated.

In the present invention, an object node and an event node are comprised in a node list arranged as a tree structure, a parent-child relationship between the event node and the object node is set based on an affiliation relationship between the specific event and an object in the specific event, so that the affiliation relationship between the specific event and the object in the specific event can be intuitively displayed in the node list.

### BRIEF DESCRIPTION OF DRAWINGS

FIG. 1 is a schematic structural diagram of a computing device according to the present invention;

FIG. 2A and FIG. 2B are schematic diagrams of a node list according to the present invention;

FIG. 3 is a flowchart of a visual logic execution method according to a first implementation of the present invention; and

FIG. 4 is a structural diagram of a visual logic execution system according to a second implementation of the present invention.

### DETAILED DESCRIPTION

In order to make objectives and technical solutions of the embodiments of the present invention clearer, the technical solutions of the embodiments of the present invention are described clearly and completely with reference to the accompanying drawings of the embodiments of the present invention. Obviously, the described embodiments are part of the embodiments of the present invention, rather than all of the embodiments. Based on the described embodiments of the present invention, all other embodiments obtained by a person of ordinary skill in the art without creative efforts shall fall within the protection scope of the present invention.

According to implementations of the present invention, an implementation of a visual logic execution method is provided. It should be noted that steps shown in the flowchart of the accompanying drawings can be executed in a computer system that can execute instructions. Although a logical sequence is shown in the flowchart, in some cases, the shown or described steps may be performed in a sequence different from the sequence herein.

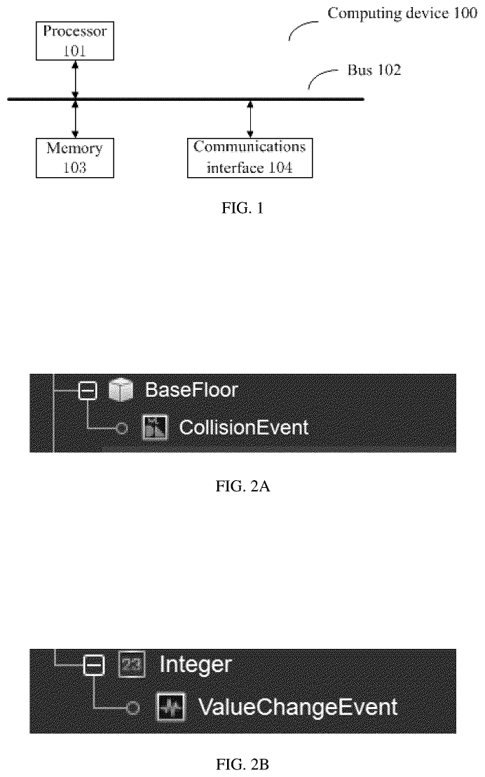

The method implementation provided in the implementations of the present application can be performed in a computing device. FIG. 1 is a schematic structural diagram of a computing device according to the present invention. As shown in FIG. 1, the computing device 100 may include one or more (only one is shown in the figure) processors 101 (the processor 101 may include, but is not limited to, a central processing unit CPU, a graphics processing unit GPU, a digital signal processor DSP, a micro control unit MCU, or a processing device such as a field programmable gate array FPGA), a bus 102, a memory 103 for storing data, and a communications interface 104 for communication functions. A person of ordinary skill in the art can understand that the structure shown in FIG. 1 is only for illustration, and does not limit the structure of the above electronic device. For example, the computing device 100 may further include more or fewer components than that shown in FIG. 1, or have a different configuration from that shown in FIG. 1.

The memory 103 can be used to store software programs and modules of databases, queues, and application software, such as program instructions/modules corresponding to the visual logic execution method in the implementation of the present invention. The processor 101 runs the software programs and modules stored in the memory 103, to execute various functional applications and data processing, that is, to implement the visual logic execution method. The memory 103 may include a high-speed random access memory, and may further include a non-volatile memory, such as one or more magnetic storage devices, a flash memory, or another non-volatile solid-state memory. In some examples, the memory 103 may further include memories remotely provided relative to the processors 101, and these remote memories may be connected to the computing device 100 through network. An example of the network includes, but is not limited to, Internet, an intranet, a local area network, a mobile communication network, and a combination thereof.

The communications interface 104 is used to receive or send data through network, and the network may include various connection types, such as wired/wireless communication links, or fiber optic cables. The specific example of the network may include Internet provided by a communication provider of the computing device 100.

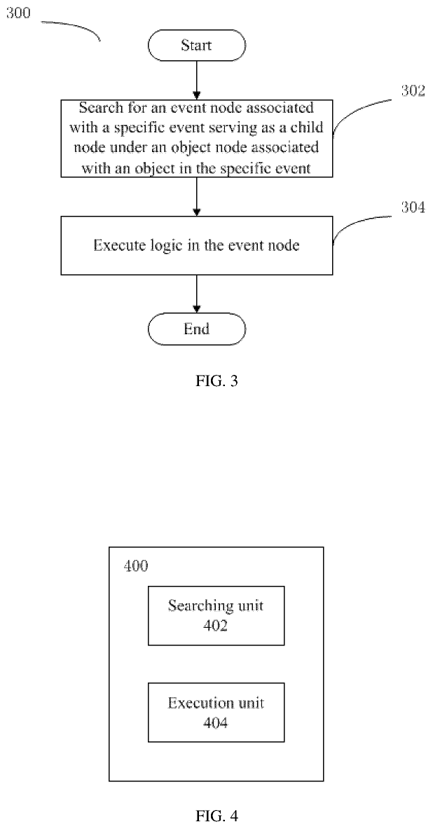

In the above operating environment, the present invention provides a visual logic execution method as shown in FIG. 3. The method can be applied to the computing device 100 and performed by the processor 101 in the computing device 100. At least one application program is installed in the computing device 100. The type of the application program is not limited in the implementations of the present invention, and may be a system application program or a software application program.

FIG. 2A and FIG. 2B are schematic diagrams of a node list according to the present invention. The node list is arranged as a tree structure for displaying and editing nodes. As shown in FIG. 2A, an event node CollisionEvent is associated with a collision event, and an object node BaseFloor is associated with a basefloor in the collision event. The basefloor can be in a physical simulation space, and the event node CollisionEvent is a child node of the object node BaseFloor. As shown in FIG. 2B, the event node ValueChangeEvent is associated with a value object change event, and an object node Integer is associated with an integer object in the value object change event. The integer object can be in a data layer. The event node ValueChangeEvent is a child node of the object node Integer.

A first implementation of the present invention relates to a visual logic execution method.

FIG. 3 is a flowchart of a visual logic execution method according to the first implementation of the present invention. As shown in FIG. 3, the method 300 comprises the following steps:

Step 302: When a specific event occurs, search for an event node associated with the specific event serving as a child node under an object node associated with an object in the specific event. The object node and the event node are comprised in a node list arranged as a tree structure.

Step 304: Execute logic in the event node.

In the present invention, when a specific event occurs, if there is an event node associated with the specific event serving as a child node under an object node associated with an object in the specific event, logic in the event node is executed, and third-party readers can quickly understand how the logic in game design is executed, so that communication and learning of developers of different games are facilitated.

In the present invention, the object node and the event node are comprised in a node list arranged as a tree structure, so that an affiliation relationship between the specific event and the object in the specific event can be intuitively displayed in the node list.

Optionally, the logic comprises script, code, blueprint, or other visual programming content customized by developer, and the logic is encapsulated in the event node.

Optionally, the specific event comprises a collision event in which two or more objects collide, and the objects in the specific event comprise two or more objects that collide.

For example, in a shooting game, a player shoots a bullet to a target, the specific event may comprise a collision event, the bullet collides with the target in the collision event, and the objects in the collision event comprise the bullet and the target that collide.

When the bullet hits the target, that is, a collision event occurs, a collision event node associated with the collision event serving as a child node under a bullet node associated with the bullet in the collision event can be searched for, and a collision event node associated with the collision event serving as a child node under a target node associated with the target in the collision event can be searched for.

Assuming that that there is no collision event node associated with the collision event serving as a child node under a bullet node associated with the bullet in the collision event, but there is a collision event node associated with the collision event serving as a child node under a target node associated with the target in the collision event, the logic in this collision event node is executed.

It can be understood that if there is no collision event node associated with the collision event serving as a child node under either the bullet node or the target node, the logic in the collision event node is not executed. If there is a respective collision event node associated with the collision event serving as a child node under both the bullet node and the target node, the logic in each collision event node is executed respectively.

The logic in the collision event node can be that if the object that triggers the collision event is a bullet, points are added to a shooter of the bullet, so that in this shooting game, if the player hits the target, the player scores. It can be understood that the logic in the collision event node can be customized by the developer. This is not limited herein.

Therefore, in the above example, because there is a collision event node serving as a child node under the target node, third-party readers can quickly understand that when the target collides, the logic in the collision event node serving as a child node is executed, so that communication and learning of developers of different games are facilitated, and an affiliation relationship between the collision event and the target can be intuitively displayed. There is no need to open the collision event node to read the logic and then understand that the logic is related to the target and the logic is executed when the target collides.

Optionally, the specific event comprises a value object change event, a function is used in the value object change event to change a value of an object, and the object in the specific event comprises the object whose value is changed.

For example, in a timing game, if a timer value is decreased by 1 per second, the specific event can comprise the value object change event, a function is used in the value object change event to change the timer value, and the object in the value object change event comprises the timer value for which a value change occurs.

When the timer value is changed by using a function, that is, a value object change event occurs, a value object change event node associated with the value object change event serving as a child node under a timer value node associated with the timer value in the value object change event can be searched for.

Assuming that there is a value object change event node associated with the value object change event serving as a child node under the timer value node associated with the timer value in the value object change event, the logic in this value object change event node is executed.

It can be understood that if there is no value object change event node associated with the value object change event serving as a child node under the timer value node associated with the timer value in the value object change event, logic in the value object change event node is not executed. If there is a plurality of value object change event nodes associated with the value object change event serving as child nodes under the timer value node associated with the timer value in the value object change event, logic in each value object change event node is respectively executed.

The logic in the value object change event node can be that if the timer value after being changed is 0, the logic of ending the game is triggered, otherwise the timer value decreases by 1 after waiting 1 second, so that in this timing game, the timer value decreases by 1 per second, and the game ends when the timer value is 0. It can be understood that the logic in the value object change event node can be customized by the developer. This is not limited herein.

Therefore, in the above example, because there is a value object change event node serving as a child node under the timer value node, third-party readers can quickly understand that logic in the value object change event node serving as a child node is executed when a value change occurs for the timer value, so that communication and learning of developers of different games are facilitated, and an affiliation relationship between the value object change event and the timer value can be intuitively displayed. There is no need to open the value object change event node to read the logic and then understand that the logic is related to the timer value and the logic is executed when a value change occurs for the timer value.

Optionally, before the logic in the event node is executed, the method further comprises the following contents:

It is determined whether the object associated with a parent node of the event node is suitable for the specific event.

When it is determined that the object associated with the parent node of the event node is suitable for the specific event, the logic in the event node is executed. Otherwise, the logic in the event node is not executed.

For example, in the above shooting game, before executing the logic in the collision event node, it is determined whether the target associated with a parent node (that is, the target node) of the collision event node is suitable for the collision event. For example, it is determined whether the target is an object having the possibility of collision. When it is determined that the target is an object having the possibility of collision, the logic in the collision event node is executed.

For example, in the above timing game, before executing the logic in the value object change event node, it is determined whether the timer value associated with the parent node (that is, the timer value node) of the value object change event node is suitable for the value object change event. For example, it is determined whether the timer value is a value object. When it is determined that the timer value is a value object, the logic in the value object change event node is executed.

It can be understood that a criterion for determining whether the object associated with the parent node of the event node is suitable for a specific event can be customized by the developer. This is not limited herein.

Optionally, the parent-child relationship between the event node and the object node is set based on the affiliation relationship between the specific event and the object in the specific event.

For example, in the above shooting game, because different players fire their own bullets to the same target, it can be determined that the collision event is affiliated to the target in the collision event. Based on this affiliation relationship, the collision event node can be set as a child node under the target node. It can be understood that it can also be determined that another collision event is affiliated to the bullet in the collision event. This is not limited herein.

For example, in the above timing game, because the timer value changes, it can be determined that the value object change event is affiliated to the timer value in the value object change event. Based on this affiliation relationship, the value object change event node can be set as a child node under the timer value node. It can be understood that it can also be determined that another collision event is also affiliated to the timer value in the value object change event. This is not limited herein.

In the present invention, the parent-child relationship between the event node and the object node is set based on the affiliation relationship between the specific event and the object in the specific event, and the affiliation relationship between the specific event and the object in the specific event can be further intuitively displayed in the node list.

It can be understood that the specific event may further comprise other event, such as the player joining the game, the player's death, or the completion of the animation playback. This is not limited herein. According to specific content of the specific event, the object in the specific event, the logic in the event node, the affiliation relationship between the specific event and the object in the specific event, and the parent-child relationship between the event node and the object node can be determined.

It can be understood that the present invention can further be used in other application development and logic editors, and is not limited to the field of game design.

A second implementation of the present invention relates to a visual logic execution system.

FIG. 4 is a structural diagram of a visual logic execution system according to a second implementation of the present invention. As shown in FIG. 4, a system 400 comprises:
a searching unit 402, configured to, when a specific event occurs, search for an event node associated with the specific event serving as a child node under an object node associated with an object in the specific event, wherein the object node and the event node are comprised in a node list arranged as a tree structure; and
an execution unit 404, configured to execute logic in the event node.

Optionally, the specific event comprises a collision event, two or more objects collide in the collision event, and the objects in the specific event comprise two or more objects that collide.

Optionally, the specific event comprises a value object change event, a function is used in the value object change event to change a value of an object, and the object in the specific event comprises the object whose value is changed.

Optionally, a parent-child relationship between the event node and the object node is set based on the affiliation relationship between the specific event and the object in the specific event.

The first implementation is a method implementation corresponding to this implementation, and this implementation can be implemented in cooperation with the first implementation. The relevant technical details mentioned in the first implementation are still valid in this implementation. In order to reduce repetition, details are not described herein. Correspondingly, the related technical details mentioned in this implementation can also be applied to the first implementation.

A third implementation of the present invention relates to a visual logic execution device, the device comprises a memory storing computer-executable instructions and a processor, the processor is configured to execute the instructions to implement a visual logic execution method, and the method comprises:
when a specific event occurs, searching for an event node associated with the specific event serving as a child node under an object node associated with an object in the specific event, wherein the object node and the event node are comprised in the node list arranged as a tree structure; and
executing logic in the event node.

The first implementation is a method implementation corresponding to this implementation, and this implementation can be implemented in cooperation with the first implementation. The relevant technical details mentioned in the first implementation are still valid in this implementation. In order to reduce repetition, details are not described herein. Correspondingly, the related technical details mentioned in this implementation can also be applied to the first implementation.

A fourth implementation of the present invention relates to a computer storage medium encoded with a computer program, the computer program comprises instructions, the instructions are executed by one or more computers to implement a visual logic execution method, and the method comprising:
when a specific event occurs, searching for an event node associated with the specific event serving as a child node under an object node associated with an object in the specific event, where the object node and the event node are comprised in the node list arranged as a tree structure; and
executing logic in the event node.

The first implementation is a method implementation corresponding to this implementation and this implementation can be implemented in cooperation with the first implementation. The relevant technical details mentioned in the first implementation are still valid in this implementation. In order to reduce repetition, details are not described herein. Correspondingly, the related technical details mentioned in this implementation can also be applied to the first implementation.

It should be noted that, each method implementation of the present invention may be implemented by means of software, hardware, firmware, and the like. Regardless of whether the invention is implemented in software, hardware, or firmware, the instruction code may be stored in any type of computer-accessible memory (for example, permanent or modifiable, volatile or non-volatile, solid-state solid or non-solid, fixed or replaceable media, etc.). Likewise, the memory may be, for example, Programmable Array Logic (PAL), Random Access Memory (RAM), Programmable Read Only Memory (PROM), read-only memory (ROM), Electrically Erasable Programmable Read-Only Memory (EEPROM), magnetic disk, optical disk, Digital Versatile Disc (DVD) and so on.

It should be noted that each unit/module mentioned in each device implementation of the present invention is a logical unit/module. Physically, a logical unit may be a physical unit, a part of a physical unit, or may be implemented by a combination of multiple physical units, the physical implementation of these logical units is not the most important, and the combination of functions implemented by these logical units is the key to solving the technical problem proposed by the present invention. In addition, in order to highlight the innovative part of the present invention, the device implementation of the present invention does not introduce units that are not closely related to solving the technical problems proposed by the present invention, which does not mean that the device implementation does not have other units.

It should be noted that, in the claims and description of this patent, relational terms such as first and second, etc. are only used to distinguish one entity or operation from another entity or operation, and do not necessarily require or imply there is such actual relationship or order between these entities or operations. Moreover, the terms “comprising”, “including” or any other variation thereof are intended to encompass non-exclusive inclusion such that a process, method, article or device including a list of elements includes not only those elements, but also includes other elements not explicitly listed or elements inherent to such a process, method, article or device. Without further limitation, an element qualified by the phrase “comprising a” does not preclude the presence of additional identical elements in a process, method, article or device that includes the element.

Although the present invention has been illustrated and described with reference to certain preferred embodiments thereof, a person of ordinary skill in the art should understood that various changes in form and detail may be made therein without departing from the spirit and scope of the present invention.

1. A visual logic execution method, wherein the method comprises:
when a specific event occurs, searching for an event node associated with the specific event serving as a child node under an object node associated with an object in the specific event, wherein the object node and the event node are comprised in a node list arranged as a tree structure; and
executing logic in the event node.

2. The method according to claim 1, wherein the specific event comprises a collision event, two or more objects collide in the collision event, and the objects in the specific event comprise the two or more objects that collide.

3. The method according to claim 1, wherein the specific event comprises a value object change event, a function is used in the value object change event to change a value of an object, and the object in the specific event comprises the object whose value is changed.

4. The method according to claim 1, wherein a parent-child relationship between the event node and the object node is set based on an affiliation relationship between the specific event and the object in the specific event.

5. A visual logic execution system, wherein the system comprises:
a searching unit, configured to, when a specific event occurs, search for an event node associated with the specific event serving as a child node under an object node associated with an object in the specific event, wherein the object node and the event node are comprised in a node list arranged as a tree structure; and
an execution unit, configured to execute logic in the event node.

6. The system according to claim 5, wherein the specific event comprises a collision event, two or more objects collide in the collision event, and the objects in the specific event comprise the two or more objects that collide.

7. The system according to claim 5, wherein the specific event comprises a value object change event, a function is used in the value object change event to change a value of an object, and the object in the specific event comprises the object whose value is changed.

8. The system according to claim 5, wherein a parent-child relationship between the event node and the object node is set based on an affiliation relationship between the specific event and the object in the specific event.

9. A visual logic execution device, wherein the device comprises a memory storing computer executable instructions and a processor, the processor is configured to execute the instructions to implement a visual logic execution method, and the method comprises:
when a specific event occurs, searching for an event node associated with the specific event serving as a child node under an object node associated with an object in the specific event, wherein the object node and the event node are comprised in a node list arranged as a tree structure; and
executing logic in the event node.

10. A computer storage medium encoded with a computer program, wherein the computer program comprises instructions, and the instructions are executed by one or more computers to implement a visual logic execution method, and the method comprises:
when a specific event occurs, searching for an event node associated with the specific event serving as a child node under an object node associated with an object in the specific event, wherein the object node and the event node are comprised in a node list arranged as a tree structure; and
executing logic in the event node.
